(19) United States
(12) Patent Application Publication
(10) Pub. No.: US 2014/0195272 A1
(43) Pub. Date: Jul. 10, 2014

(54) SYSTEMS AND METHODS OF GAMIFICATION FOR A DRIVING PERFORMANCE PRODUCT

(71) Applicants: Hassan Sadiq, Hampshire (GB); Shaun Michael Gwilliam, Gloucestershire (GB)

(72) Inventors: Hassan Sadiq, Hampshire (GB); Shaun Michael Gwilliam, Gloucestershire (GB)

(21) Appl. No.: 13/837,955

(22) Filed: Mar. 15, 2013

Related U.S. Application Data
(60) Provisional application No. 61/749,600, filed on Jan. 7, 2013.

(51) Int. Cl. G06Q 40/08

(52) U.S. Cl. CPC G06Q 40/08
USPC 705/4

(57) ABSTRACT

Systems and methods of adding a gamification layer or platform to a driving performance product, such as, a usage-based insurance product. One method includes determining a game-based objective based on the driving performance of a driver, offering a real-world or virtual incentive to the driver to complete the objective, tracking the driving performance of the driver, and determining if the driver achieves the objective. Reduced usage-based insurance premiums may be offered as an incentive to the driver. Other methods include customized game development and continuous improvement strategies.

### CROSS REFERENCE TO RELATED APPLICATIONS

This application claims priority to, and the benefits of, U.S. provisional application Ser. No. 61/749,600 filed on Jan. 7, 2013, which is incorporated by reference herein in full.

### BACKGROUND

Providing usage-based insurance, other insurance products, and/or fleet management can include capturing data associated with driving performance (e.g., driving activity or “usage”), which drivers may be reluctant to embrace.

The following patent applications are incorporated by reference herein in full: U.S. provisional application Ser. No. 61/744,755, U.S. provisional application Ser. No. 61/762,547, and U.S. application Ser. No. 13/835,381.

### SUMMARY

In one embodiment, a method of providing a game-based driving performance application, including determining an objective associated with driving performance of a driver, communicating at least one objective to the driver, receiving data associated with activity associated with the objective, determining a result based on comparing the data to the objective, and reporting the result to at least one user, where communicating the objective to the driver comprises a game-based interaction.

The descriptions of the invention do not limit the words used in the claims in any way or the scope of the claims or invention. The words used in the claims have all of their full ordinary meanings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention.

FIG. 1 is a chart showing an exemplary insurance platform;

FIGS. 2-3 depict an exemplary gamification platform associated with an exemplary insurance platform;

FIGS. 4-5 are flowcharts showing the steps of exemplary embodiments of a gamification method;

FIG. 6 is a flowchart showing the steps of an exemplary embodiment of a driver profile update;

FIGS. 7-18 show exemplary screenshots of exemplary embodiments of a gamification application;

FIGS. 19-21 show exemplary screenshots of exemplary embodiments of a gamification application on an exemplary mobile device; and

FIG. 22 includes a depiction of exemplary communication protocols and exemplary devices containing the gamification application.

### DESCRIPTION

The following includes definitions of exemplary terms used throughout the disclosure. Both singular and plural forms of all terms fall within each meaning:

“Address”, as used herein, includes but is not limited to one or more e-mail addresses, a distribution list including one or more e-mail addresses, uniform resource locator (URL) and file transfer protocol (FTP) locations or the like, network drive locations, a postal address, a combination of an e-mail address and a postal address, or other types of addresses that can identify a desired destination.

“Computer Readable Medium”, as used herein, includes but is not limited to any memory device, storage device, compact disc, floppy disk, or any other medium capable of storing data temporarily and/or permanently that can be interpreted by a computer.

“Device”, as used herein, includes any machine or component that attaches to and/or communicates with a computing device. Examples of peripheral devices, which are separate from a main computing device, include disk drives, printers, mice, and modems. Examples of integrated peripherals, which are incorporated into a main computing device, include central processing units and application specific integrated circuits. Most devices, whether peripheral or not, require a program called a device driver that acts as a translator, converting general commands from an application into specific commands that the device understands.

“Game”, as used herein, includes any game-based or game-like activity, including interfaces, presentation of game objectives, results, gamified business processes, and gamified business functions. “Gamification” includes game-based experiences that include the use of game mechanics to present information, interfaces, objectives, feedback, products and/or services from business partners, etc., including outside of the realm of playing a game.

“Integrated Circuit” (“IC”), as used herein, includes, but is not limited to a small electronic device made out of a semiconductor material. Integrated circuits are used for a variety of devices, including microprocessors, audio and video equipment, and automobiles.

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

“Logic”, synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other logic device. Logic may also be fully embodied as software.

“Network”, as used herein, includes but is not limited to the Internet, intranets, Wide Area Networks (WANs), Local Area Networks (LANs), and transducer links such as those using Modulator-Demodulators (modems).

“Platform”, as used herein, includes but is not limited to a computing system that combines hardware and software, including application frameworks. The platform may include a computer architecture, operating system, programming languages, and related user interfaces, including run-time system libraries and/or graphical user interfaces. Providing a “platform as a service” (PaaS) is a category of computing services that may provide an integrated platform with specific application solutions as a service, with various levels of scalability. Services may include providing specialized and/or customized hardware, such as, for example, networks, servers, storage, interface devices, etc., and software, such as, for example, applications, interfaces, security, etc. Hardware and/or software associated with the services may or may not be dedicated to one platform. Providing a PaaS may include development, testing, deployment, hosting, maintenance, updating, etc. A PaaS may include the capability to integrate with various outside and/or private systems, such as, for example, web services, databases, and networks, utilizing, for example, Simple Object Access Protocol (SOAP) and Representational State Transfer (REST) interfaces.

“Signal”, as used herein, includes but is not limited to one or more electrical signals, analog or digital signals, one or more instructions, a bit or bit stream, or the like. The term “command” is synonymous with “signal.”

“Software”, as used herein, includes but is not limited to one or more computer executable instructions, routines, algorithms, modules or programs including separate applications or code from dynamically linked libraries for performing functions and actions as described herein. Software may also be implemented in various forms such as a stand-alone program, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

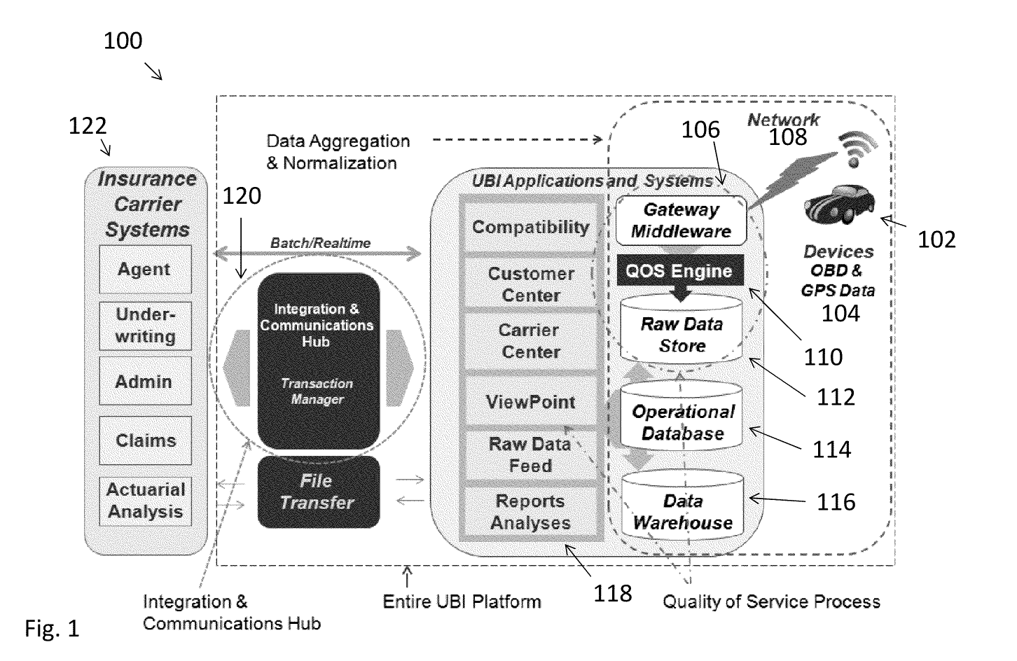

FIG. 1 shows an exemplary insurance support/enhancement platform 100, including exemplary hardware and software elements supporting carriers providing insurance, including, for example, usage-based insurance (UBI). As used herein, UBI includes usage-based insurance, behavior-based insurance (BBI), and other incentive or discount based insurance programs that may include use and behavior based elements including, for example, mileage, trips, driving performance and habits, geospatial data, etc. In other embodiments, the platform 100 may be associated with a driving performance product or application applicable to commercial/fleet management and/or self insurers. Clients of the platform or driving performance product may include insurance carriers, such as UBI carriers, commercial/fleet managers, self insurers, etc.

Insurers, for example, may be property/casualty insurance carriers that may use a driving performance product, such as a UBI product, for personal lines of insurance or commercial lines of insurance. Self-insurers, for example, may be companies with a large fleet that may self-insure an underlying layer of risk and may buy an umbrella layer of coverage over the self-insured layer. Self-insurers may use a driving performance product, such as a UBI product, that will allow them to gather the same data on drivers that an insurer tracks. Fleet managers, for example, may be companies with fleets of commercial vehicles and may have commercial insurance with a company that may not offer UBI, but they may be eligible for a discount from their insurance carrier if they employ a driving performance product, such as a UBI product, to monitor their drivers' performance. In other situations, fleet managers may use a driving performance product, such as a fleet management product (e.g., a subset of a UBI product), with features that allow them to track location, fuel consumption, hours of vehicle operation, etc.

A UBI product is an exemplary driving performance product. For simplicity, this application may refer to exemplary UBI products, programs, systems, features, transactions, etc. However, references to UBI are exemplary and include all of the exemplary driving performance products described above, among others.

In the exemplary platform 100 of FIG. 1, data, such as, for example, latitude/longitude of a vehicle 102 is captured and/or transmitted, for example, wirelessly from a device 104, associated with the vehicle 102, such as a dongle device, on-board diagnostic (OBD) device, global positioning system (GPS) device, iOS or Android device, smart phone, tablet, or other telematics device to one or more gateways 106 via, for example, network 108. The data from the device 104 may include information associated with driving performance related to, for example, a UBI product, such as, for example, driving behavior, vehicle location, etc. In some embodiments, data captured and/or transmitted by the device 104 may include data from more than one data source or device. For example, the device 104 may transmit data captured from the vehicle 102 OBD device and/or data captured from a GPS system included in the device 104. Gateways 106 may include a device 104 manufacturer's or provider's gateway or a common gateway established for the platform 100. In some embodiments, data may be captured and/or transmitted directly from the vehicle 102, such that the vehicle 102 or a component of the vehicle 102 is the device 104. The device 104 may or may not be connected to the vehicle 102. Data aggregation and normalization can occur using, for example, systems and methods described in U.S. provisional patent application Ser. No. 61/744,755 and U.S. application Ser. No. 13/835,381, which are both incorporated herein by reference in full.

Data may be processed through a Quality of Service (QOS) application or engine 110, which can evaluate, for example, data packets and aggregated packets (e.g., trips) and can pass results through algorithms for data retention, display, and/or use. Resulting raw data can be stored in raw data store 112 and passed to an operational database 114 and data warehouse 116, which may allow some applications 118 (e.g., Carrier Center, Customer Center, ViewPoint, etc.) to access the data directly and/or other applications (e.g., Actuarial Analysis) to access the data via, for example, File Transfer Protocol (FTP). An integration and communications hub 120 can manage transactions to and from other systems and applications, including, for example, the exemplary insurance carrier systems 122. These communications and transactions may include, for example, logistics for ordering the device 104, dashboards for viewing driving results as recorded by the device 104, processes for managing insurance rates, etc.

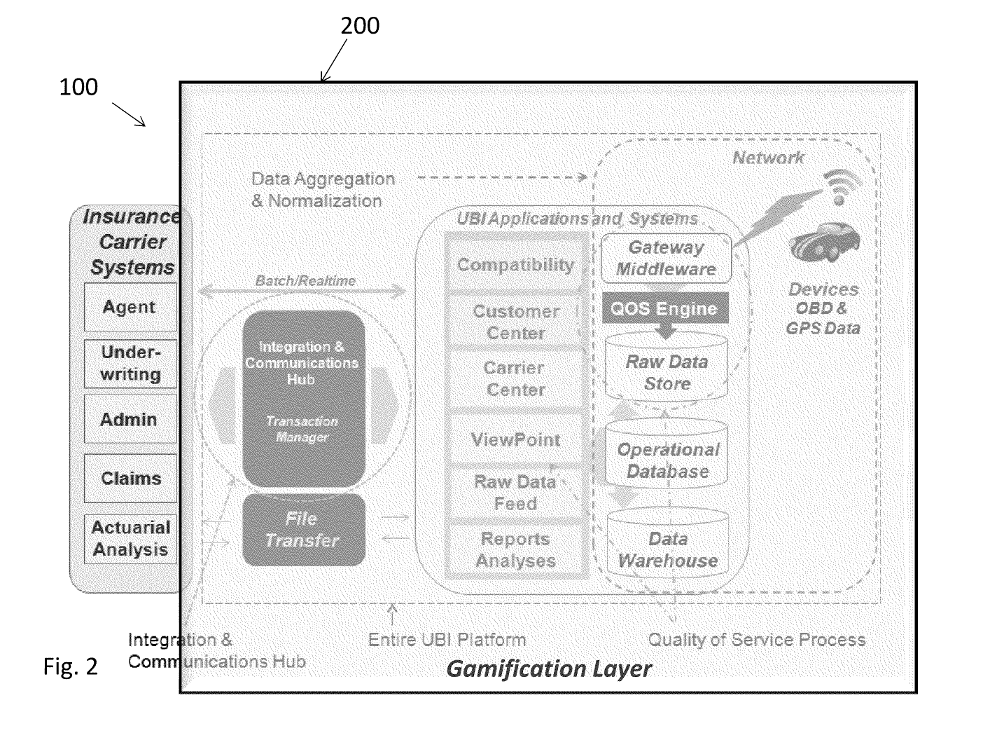

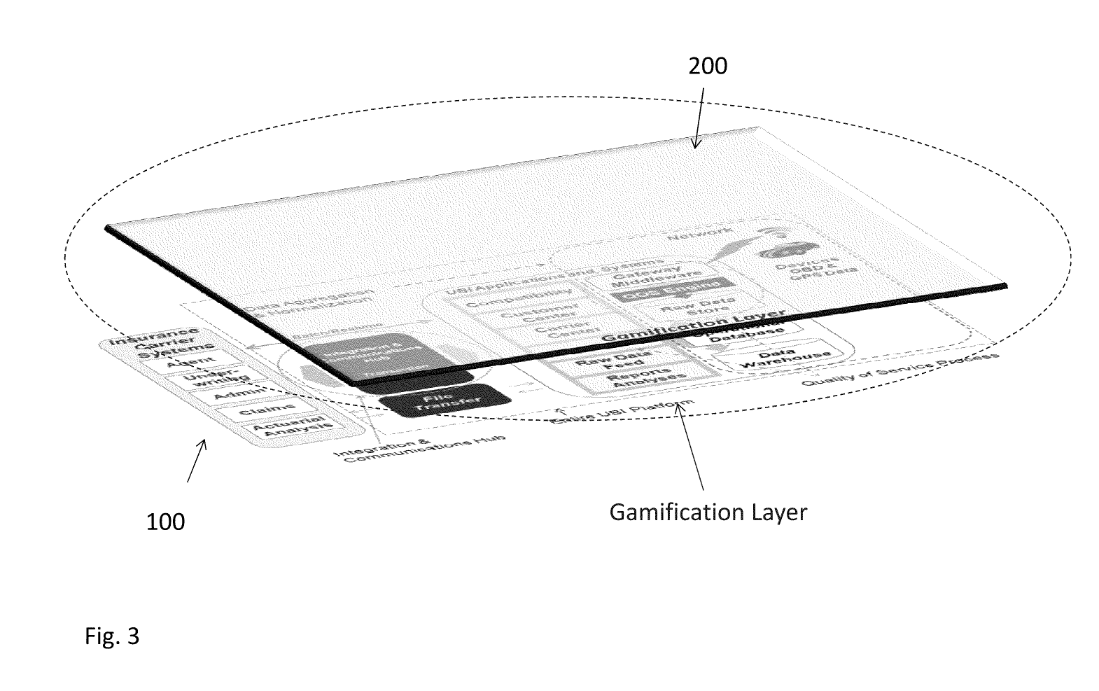

FIGS. 2 and 3 depict a gamification layer or platform 200 “on top of” the exemplary insurance platform 100. The gamification platform 200 may include various hardware and software components capable of implementing the functions described below. In this manner, the gamification platform 200 adds game-design elements and mechanics to the other elements of the insurance platform 100, without adversely impacting how the elements of the insurance platform 100 perform their native, insurance-based functions, as described above. For example, games or objectives may be communicated to drivers, along with an incentive to achieve the objective, in an attempt to achieve a goal of improving or reducing the risks associated with certain driving behavior. A gamification platform 200 can add to native functions to create a customizable insurance platform that integrates game-based functionality and interfaces, including game-design elements and mechanics, with an existing property/casualty carrier's insurance products and customer systems, including, for example, sales, marketing, actuarial analysis, product design, pricing, policyholder service, etc. The gamification platform 200 may also be used to design new products and services and develop a deeper understanding of customers through analytics. In addition, the gamification platform 200 may be linked to other systems, for example, fleet systems for self-insurance, as mentioned above.

The gamification layer or platform 200 may be embodied as a gamification application and may include other applications. For example, as described in detail below, a user interface may allow the user to interface with the gamification platform 200. In one embodiment, the user interfaces with the gamification platform 200 before and/or after driving, but not while driving, although data associated with the user's driving can be captured while the user is driving. In another embodiment, the gamification platform 200 may disable access to the application by the user while the user is driving.

The gamification platform 200 may be created by, hosted by, and/or used by providers or those associated with providers of driving performance products, such as, for example, UBI.

Generally, a gamification platform 200 may be used to enrich a user's experience with a system, for example, platform 100, to better achieve system goals via, for example, increased participation, communication, feedback, positive reinforcement, enjoyment, etc., by creating a game-based environment. For example, a goal of the insurance company or self-insurer employing a gamification platform 200 may be to provide incentive to users to adopt certain beneficial behaviors associated with their insurance coverage or policies, which may include, for example, UBI. For instance, an auto insurance carrier may want to provide incentive to a user to not exceed the speed limit while driving. The insurance carrier may offer real or virtual incentives to drivers that obey speed limits and can monitor the driving speed of the user via the data collection elements discussed above in relation to insurance platform 100, within the gamification platform 200.

As illustrated in this application, blocks or steps of flowcharts represent logic functions, actions and/or events performed therein. It will be appreciated by one of ordinary skill in the art that electronic and software systems involve dynamic and flexible processes such that the illustrated blocks and described sequences can be performed equivalently in different sequences or in parallel. It will also be appreciated by one of ordinary skill in the art that elements embodied as software may be implemented using various programming approaches such as, for example, machine language, procedural, object-oriented, or artificial intelligence techniques. It will further be appreciated by one of ordinary skill in the art that, if desired and appropriate, some or all of the software can be embodied as part of a device's operating system.

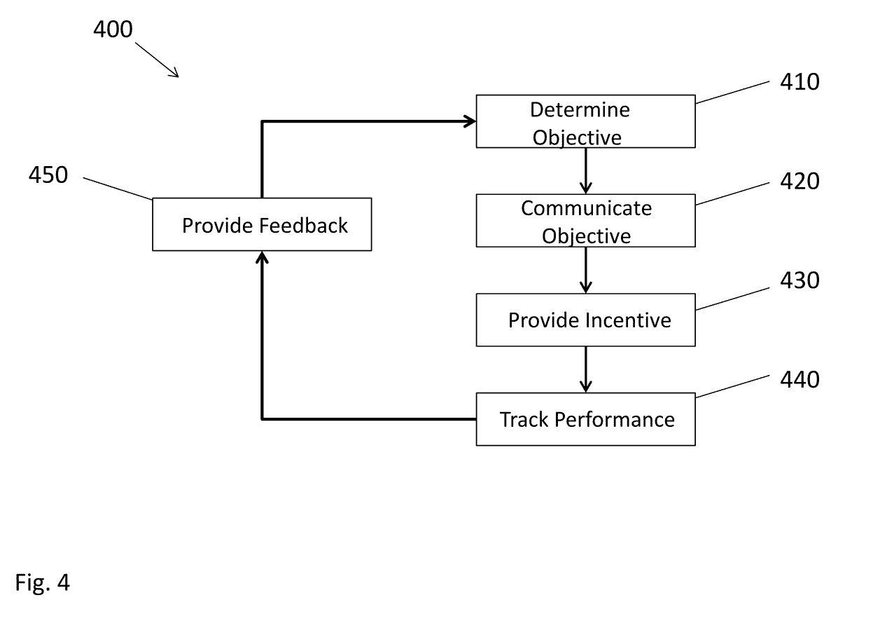

FIG. 4 shows steps associated with an exemplary gamification platform 200 and/or an exemplary process 400 associated with the gamification platform 200. Any or all of the steps associated with process 400 may include game-based interactions with the driver. At 410, the gamification platform 200 can determine and/or generate an objective (in the form of a game) for the driver. At step 420, the gamification platform 200 can be used to communicate the objective to the driver. Proceeding to step 430, an incentive for complying with the objective is provided or offered to the user. At step 440, the gamification platform 200 tracks performance and determines a result of the objective (or game). Reporting feedback based on the performance result is provided at 450. After providing feedback, another objective may be determined at 410. All of these steps, and in particular steps 420, 430, 450, may be implemented and/or communicated to the user with an interface that creates a game-based experience for the user.

For example, using the process 400 of FIG. 4, the gamification platform 200 may be used to reduce the incidence of loss (e.g., accidents related to excessive speed). At 410, the process 400 may determine that a driver's objective is to comply with speed limits. The objective may be based on prior driving performance of the driver and/or prior results vis-à-vis prior objectives. At 420, the process 400 communicates the speed compliance objective to the driver and suggests a game or other game-based process, such as, for example: accomplishing twenty trips with fewer than 5% of them involving speeding; or achieving the least number of speeding events in a household. At 430, the process 400 provides an incentive (e.g., virtual rewards, partner discounts, and/or reduced insurance rates or premiums) for achieving or completing the objective, i.e., obeying speed limits. At 440, the driver's speed performance is tracked. At 450, the driver's compliance level is communicated to the driver, along with any incentives. Depending on the performance tracked at 440 vis-à-vis the objective, a new or repeated objective may be determined for the driver at 410.

To determine an objective for a user at 410, the gamification platform 200 and/or process 400 may compare a user's profile to conditional rules defining multi-dimensional behaviors. Based on this comparison, at 420, the process 400 can provide virtual and real world games to the user that lead to rewards and recognition. The rewards and recognition, used as incentives at 430, are associated with satisfaction of the rules, enabling, for example, insurance carriers and consumers (users) to work toward mutually beneficial goals, including, for example, accident or loss reduction, fuel savings, reduced insurance costs, and/or greater safety within their communities. Data aggregation and analysis of user engagement with policy-linked game technology can expand the range of variables available to property/casualty insurers for sales and marketing programs, product design, and individualized insurance pricing, which can transform static and behavior-based variables into actionable results.

Exemplary uses of the gamification technology can include service transactions (e.g., location-based services), driver analysis (e.g., improved understanding of behavior), current product analysis (e.g., improved segmentation and pricing, changed product offers), driver behavior (e.g., change with reduced incidence of loss), new product design (e.g., new approaches to location-based marketing, community-based sales), claims transactions (e.g., improved response mechanisms), etc.

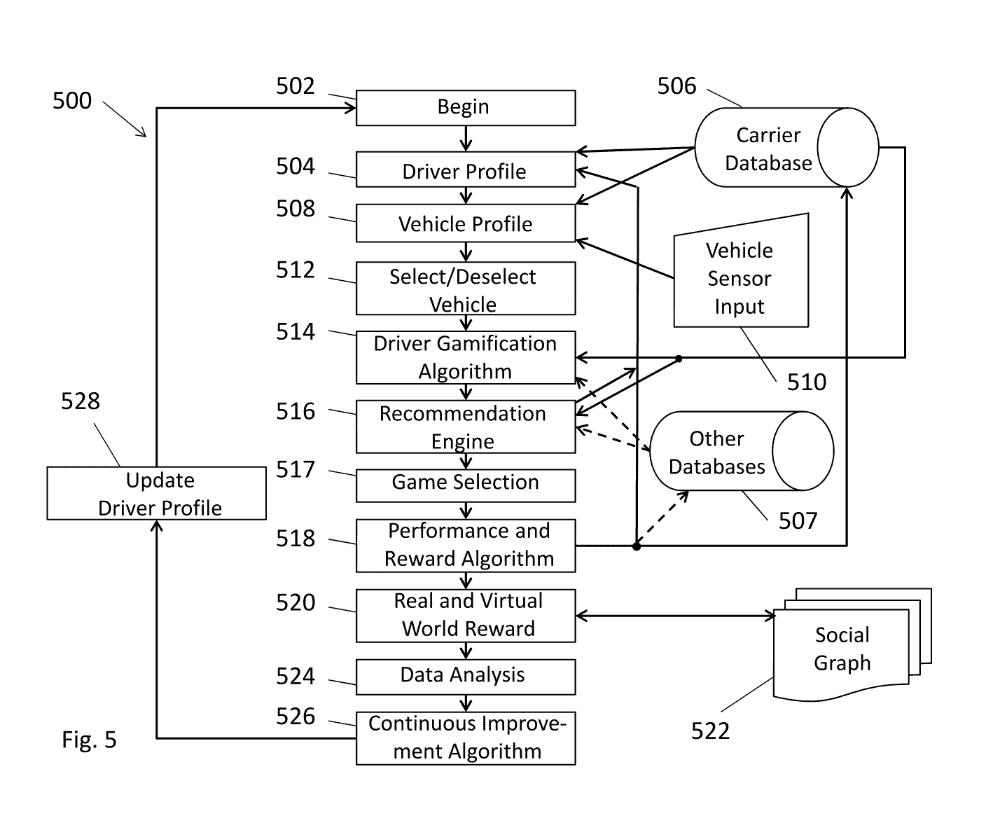

In the exemplary embodiment shown in FIG. 5, the gamification platform 200 uses a customizable application/process 500 that may provide a dynamic game engine to apply game mechanics to the problem of reducing the number and severity of risky driving behaviors and/or events, such as, for example, excessive speed, hard braking, sudden acceleration, etc. Any or all of the steps associated with process 500 may include game-based interactions with the driver. At step 502, the process 500 may begin with a driver logging into the carrier's customized gamification platform 200 via a user interface. The driver can interface with the customized gamification platform 200 through a secure website or application using, for example, a PC, MAC, tablet or iOS or Android device. In other embodiments, the driver may also access the platform 200 via mobile devices and their associated wireless networks. The login may also include other information, such as, for example, registration and other demographic information from a carrier database, vehicle manufacturer's database, social media application, etc., which may also be used for login/credentials.

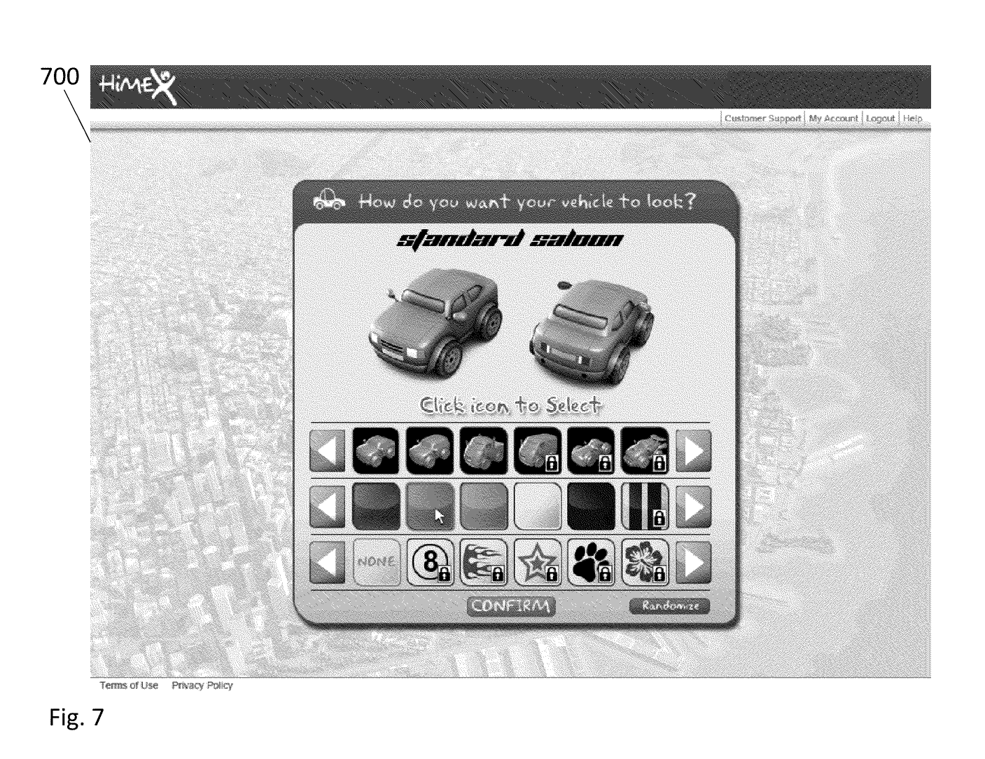

Next, at 504, the driver's profile can be established and/or updated. For example, current driving event history and insurance rating information from the carrier database 506 may be included in the driver profile within the platform 200. Driving event history can be created, for example, through data capture from a device 104, such as, for example, a dongle or GPS device, and stored in the carrier database 506 and/or driver profile 504. All vehicles 102 connected via a device 104 can collect data on the behavior of the driver (e.g., acceleration, braking, cornering, speeding, etc.) as well as other information, such as, for example, trip location, distance driven, and trip start and end times. Data may be transmitted real-time or near real-time while the vehicle ignition is on. In other embodiments, data may be stored for later transmission. As part of their driver profile 504, drivers can also personalize avatars for themselves and their vehicles (see, e.g., screen 700 of FIG. 7).

A driving event in the driver profile 504 may be an occurrence of driving behavior that exceeds a pre-defined value for a particular parameter, such as, for example, acceleration, braking, cornering, or speeding. Each event can be associated with or tagged to the vehicle and the driver associated with that vehicle at the time of the event, which will be described in more detail below. An event severity may be associated with a risk associated with the event generated by the driver's vehicle. For example, when a braking event occurs, the database can evaluate information about the risk of that action, and can assign a rating using a rating scale of, for example, 0-10 (low to high risk). For example, sudden braking while driving 10 mph may be assigned a low event severity rating while sudden braking at 70 mph may be assigned a high event severity rating.

The driver profile 504 may be a finely graded view of an individual driver based on, for example, demographics, behaviors and choices made while connected to the gamification platform 200, both while driving and engaging with the gamification platform 200 when not driving. For example, using the data obtained within the UBI platform 100, a risk level (e.g., embodied as a driver score end/or vehicle score) may be calculated for the user. The gamification platform 200 can recommend behavior changing games, safety tips, and videos, which may motivate the driver to reduce their risk level, with the potential for rewards, for example, earning a greater insurance discount, qualifying for other insurance, real or virtual rewards, other incentives, etc.

In one embodiment, a driver profile 504 may be a function of data derived from the exemplary UBI platform 100 and the gamification platform 200. For example, regarding the UBI platform 100, the driver profile 504 may be a function of data derived from: 1) event and trip data (e.g., GPS and OBD data on location, speed, cornering, braking, accelerating etc. plus geospatial data); and 2) historical driver information from the carrier database 506 (e.g., age, gender, marital status, number of years licensed, accident, claim and violation history, etc.).

In addition, for example, regarding the gamification platform 200, the driver profile 504 may be a function of data derived from: 1) frequency, method, and/or results of interactions within the gamification platform 200, either online or via a mobile application, including, for example, when a driver does any of the following: plays an online game; accepts a game recommendation and completes/doesn't complete the activity; reads a text message; reads educational material; views a video; conducts a search via platform (e.g., route mapping, find a restaurant, locate a vendor partner); uses a social media connection via the gamification platform 200 (e.g., Twitter, Facebook, Instagram, LinkedIn, etc.); accepts an offer from a vendor partner (e.g., fuel discount, car parts, safety course, free coffee at night); or activates or accepts a reward (e.g.: virtual rewards to unlock a level, selects a new avatar, posts status/badges; real rewards to redeem/buy from vendor partners; and insurance discounts from carrier); 2) changes in driving behavior that can be linked to interactions with the platform 200, including, for example: reduction in number of events (e.g., speeding, cornering, braking; source: carrier database 506 operating in UBI platform 100); reduction in number of claims, accidents and traffic citations (source: carrier database 506 driver history); fewer miles driven (source: UBI platform 100); avoidance of unsafe travel routes or areas (source: gamification platform 200 captures for driving behavior heat map); frequency of login to customer center (e.g., Evogi Group's MyDriveAdvisor) to check driving performance status; and 3) driving behavior heat maps (described in more detail below), which can provide visual representation of one trip or multiple trips with alerts for significant events, including, for example: similar trips that are overlaid on a map with events pinpointed; events by type are flagged as “Extreme” or “Severe” based on parameters set by the carrier; driver may tag trips (e.g., work, retail, friends); and trips may be grouped for continuous learning algorithm (e.g., “other dates this event occurred at this location” or “other locations this event occurred at”).

A trip in the driver profile 504 may include data associated with a single driving journey, for example, from the time the vehicle's ignition is switched on until the ignition is switched off (e.g., trip location, distance driven, trip start and end times, and geospatial information, such as, for example, weather, traffic, etc.). Events can be aggregated by trip, using a rule base, for display to drivers in the driver profile section of the platform 200.

The carrier database 506 may provide insurance-related information to the driver profile 504 about, for example, demographics and rating variables. Other external databases (not shown) may also be linked to add other information, such as, for example, driver information.

At 508, the application may also establish or update a vehicle profile. The vehicle profile 508 can include data about the vehicle's condition and location, which can be updated through a variety of sources, including direct input by the driver. Vehicle profile 508 information may include various vehicle specific information, such as, for example, the make and model, color, wheel size, and options, such as, for example, anti-lock brakes (ABS) and telematics capabilities, may be updated from several sources, such as, for example, the carrier database 506, a vehicle manufacturer's database, by the driver, etc. Other external databases may also be linked to add vehicle information to the vehicle profile 508.

A vehicle sensor input 510, such as, for example, a device 104, may provide real-time or near real-time information from the connected vehicle to the platform 200 via platform 100, including information associated with driving events, such as, for example, location, speed, accelerations, etc. The vehicle sensor 510 can update the status of the vehicle, which may include, for example, mileage, fuel and fluid levels, maintenance history, etc. The platform 200 may be designed to accept vehicle profile data from any type of vehicle sensor, including devices 104, such as, an original equipment manufacturer (OEM) or aftermarket OBD, a mobile device, or any other device capable of transmitting vehicle status and location data. The location of the vehicle for the driving event history may be determined using data from the vehicle sensor 510. The platform 200 can allow sensor data to be passed in real-time, near real-time, stored, and/or pre-cached via a pre-defined interface.

A vehicle may be selected or deselected at module 512. If a policy includes only one car and one driver, this step may be bypassed. If there are more than one potential drivers for one vehicle or more than one vehicle for one driver, a driver can select a vehicle that the driver will be driving before starting a trip, so that the driving event history for the trip is connected to or associated with the appropriate driver. In other words, a one-to-one relationship should be established between a driver and a vehicle for any trip. The driver can complete a vehicle selection via a user interface. After a trip is concluded, the driver may also deselect a vehicle to prevent a subsequent different driver from associating the different driver's trip with the original driver. In other embodiments, such as, for example, with a self-insured fleet of vehicles, the platform 200 may be configured to automatically deselect a vehicle at the end of a trip. Vehicle selection may be presented to a driver via a screen similar to that shown, for example, in FIG. 7.

The process 500 may then proceed to the driving gamification algorithm 514. The driving gamification algorithm 514 is designed to recommend games for the driver, for example, based on data sets from the driver profile, vehicle profile, and/or other data sets. For example, in one embodiment:

Gamification algorithm/Potential recommended games 514=f(driver profile data 504)+f(vehicle profile data 508)+f(games offered by carrier)+f(matching carrier objectives with drivers)

Regarding the vehicle profile 508, if the vehicle VIN is known, vehicle data may be extracted from a VIN database. If the driver is playing a stand-alone game, they may enter some or no data. The games currently being offered by the carrier may include a basic game design and approach to gamifying driving behavior improvement, as described in more detail below. Regarding matching carrier objectives with drivers, for example, objectives may be based on the vehicle score, desired changes in driving behavior, and/or desired engagement within gamification platform 200.

For example, based on a driver's driver profile 504, vehicle profile 508, and the other factors mentioned above, games may be generated, developed, and/or recommended by the driver gamification algorithm 514, such as, for example, participation in individual and/or group games or challenges. For example, driver profile data sets may include information about driver demographics, games the driver has already completed, past performance on attempted games, driver events, etc. Based on this information, the driving gamification algorithm 514 may recommend games most applicable to that particular driver, may identify related driving behaviors and games, may suggest partners that offer services or products (e.g., driving schools for remedial driving classes), may offer alternative insurance products or discounts that are developed by carriers through analysis of game-based activities.

The platform 200 can create driver awareness of behavior that may be risky and can provide incentives for the driver to conform to behavior or to change behavior to minimize risk. The carrier may be able to achieve long-term or permanent behavior changes by inducing short-term behavior changes via incentives. In this manner, the short-term behaviors may become or lead to, for example, with or without further incentives, driving habits supporting long-term or permanent behaviors. For example, games designed to focus on basic driving maneuvers or behaviors most likely associated with teen drivers may be recommended to a teen driver. In another example, games designed to focus on speed compliance may be recommended to a driver that regularly exceeds the speed limit. In another example, games with a difficulty greater than a previously completed game of the same type may be recommended.

In another example, the structure of the insurance product may change as the carrier incorporates results of driving behavior, demographic data, game-playing performance, geospatial data, interaction with external partners, etc. The risk profile of the driver himself may change as the driver interacts with game mechanics, permanently changing the driver's style and habits of driving. In this embodiment, for example, the carrier may create insurance offerings for smaller, discrete groups of drivers who present similar responses to game mechanics In this manner, the application 500 facilitates changes in the way the consumers (e.g., drivers) may buy insurance, what type of insurance products or discounts they are offered and are willing to buy, how the carrier structures risk and creates new programs for different groups of drivers, etc. For example, there may be a group, such as, for example, 25-35 year-old males, who are skilled at games and whose game performance is highly correlated with improvements in driving behavior, as well as, for example, additional diagnostics and demographics.

Regarding game design, many variables and/or factors are considered for a game designed to drive improvement in particular events. For example, the gamification algorithm 514 can consider factors and prior situations that were involved in the driver's events in order to generate a customized game. Additionally, games can be generated with other similar situations and conditions (e.g., if most events involved snowy conditions on a freeway in rush hour, a game may also be generated to educate the driver on snowy conditions on other road types/time of day).

In one embodiment, the following variables/factors are considered in designing a customized game to address “Sudden Braking” events by a driver:
Road conditions
   Type of surface: pavement, blacktop, gravel
   Weather-related: dry, wet, flooding, icy, black ice, sleet, snow, heavy snow, windy, tornado, hurricane
   Type of road: Freeway, highway, divided highway, 2 lane road, one way road
Time of day
   Full daylight, dawn, dusk, night
   Combined with direction of travel: driving into sun at dawn or dusk
   Combined with Route: in rush hour traffic or not
Other Events that were observed on similar Trips
   High Speed
   Cornering
   Sudden Acceleration
Vehicle Profile
   Model year
   Condition of brakes
   Condition of tires
   Weight of vehicle
   Engine size
   Does vehicle have ABS brakes?
   Does vehicle have Turbo?
Driver Profile
   Demographics
   Prior Games results

In another embodiment, the following variables/factors are considered in designing a customized game to address “High Speed” events by a driver:
Road conditions
   Type of surface: pavement, blacktop, gravel
   Weather-related: dry, wet, flooding, icy, black ice, sleet, snow, heavy snow, windy, tornado, hurricane
   Type of road: Freeway, highway, divided highway, 2 lane road, one way road
Time of day
   Full daylight, dawn, dusk, night
   Combined with Route: in rush hour traffic or not
Other Events that were observed on similar Trips
   Sudden braking
   Cornering
   Sudden Acceleration
Vehicle Profile
   Model year
   Condition of tires
   Weight of vehicle
   Engine size
   Does vehicle have Turbo?
Driver Profile
   Demographics
   Prior Games results

At module 516, the recommendation engine can use the results of the driving gamification algorithm 514 and information from the carrier database 506 to suggest objectives or games for the driver. The terms games and objectives may be used synonymously. For example, in one embodiment:

Recommended games 516=f(historic trips)+f(events)+f(weather conditions during the trips)+f(my age)+f(vehicle profile 508)−f(past games played)

The recommendation engine 516 can have configurable parameters, for example, which may be set by insurance carriers, other businesses, local communities, or other groups. One or more games involving a specific mission or measurable tasks to be achieved may be recommended. These gaming options may exist in the real world and/or in a virtual world, such as, for example, in the application 500, which may include, for example, the HIMEX Virtual World. In various embodiments, games and their associated goals may be set for individuals, small groups or communities. For example, a carrier may want to prioritize games that focus on winter driving skills in communities that experience harsher winter weather. In another example, based on an individual carrier's unique actuarial analyses, a carrier may want to prioritize games that focus on particular behaviors most impacting certain risk factors. In another example, a carrier may want to recommend games specific to unique groups, such as, for example, motorcyclists or drivers towing boats or trailers.

In addition, at 516, the driver may be prompted to look at driving tips and safety videos, which may be based on the driver profile 504. The driver may be rewarded for looking at the tips/videos and the driver profile 504 can be updated.

At 517, the recommended games are presented to the driver and the driver selects a game for participation. The presentation is a gamified interaction—whether it is an actual game, gamified business process, gamified business function, etc. After selection, the driver participates and the results are tracked and presented to the driver online or in a mobile application.

In some embodiments, the user interface, such as, for example, the HIMEX Virtual World, may be the foundation of the property/casualty gamification platform 200. For example, the HIMEX Virtual World may include spatially available data and live, real-time data, combined for a rich contextualized environment, including, for example, traffic, weather, landmarks, road conditions, etc. As the user travels on trips, an on-board device 104 or mobile phone can capture selected data about each trip and record it into the driver's profile 504. In addition, the user interface can provide a customized combination of any or all of several gamification elements for a carrier, such as, for example: personalization using avatars for motor vehicle, drivers, passengers, pets, homes, jewelry, artwork, fleets of motor vehicles, or commercial property; missions, quests or achievements designed for a carrier's target market, for specific insurance or safety objectives, or cost reduction objectives; recognition and status within a carrier or user-defined community; and real and virtual world rewards for achieving goals or advancing through game levels, paid in either virtual or real currency or discounts. The platform 200 and/or user interface may be designed for each insurance carrier, using, for example, the HIMEX Virtual World gamification platform for Property/Casualty Insurance.

The insurance consumer (driver) can see his activity within the platform 200 via a user interface, such as, for example, a customer center, as customized by, for example, HIMEX for the insurance carrier. Access may be made available through a portal, for example, at the carrier's website online, via PC, MAC, tablet or Android or iOS device, including mobile devices.

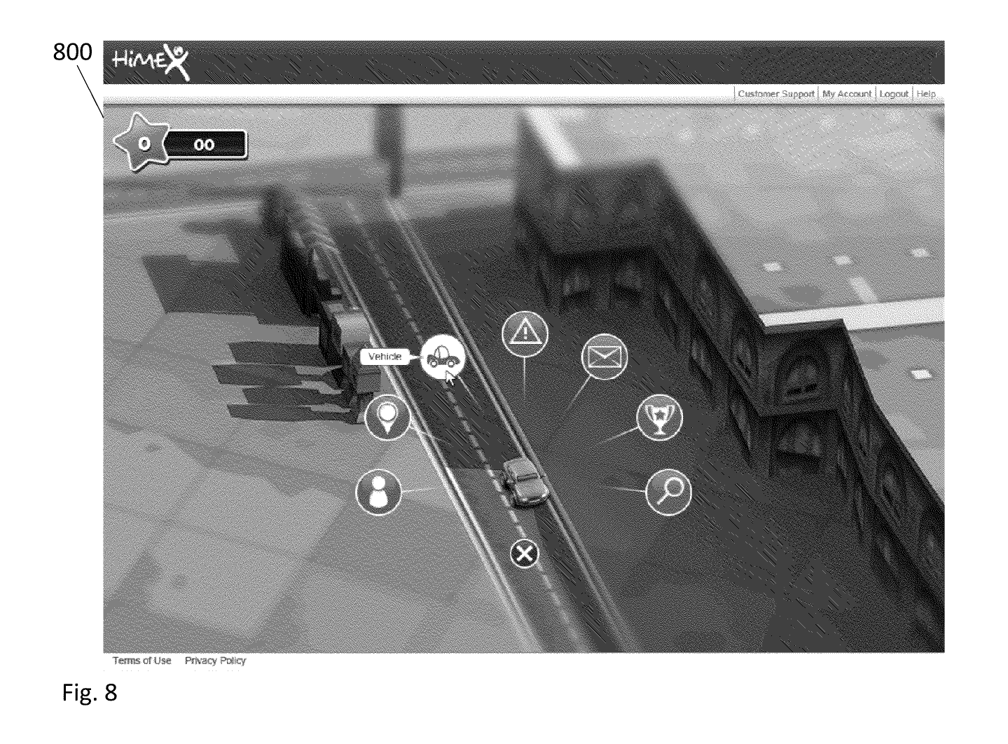

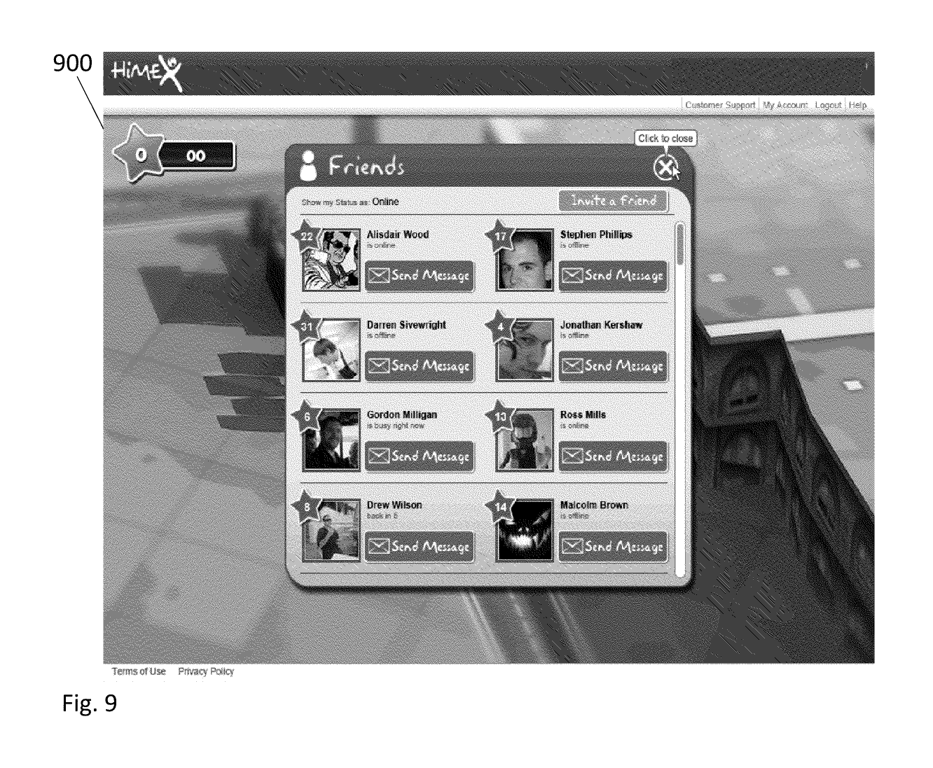

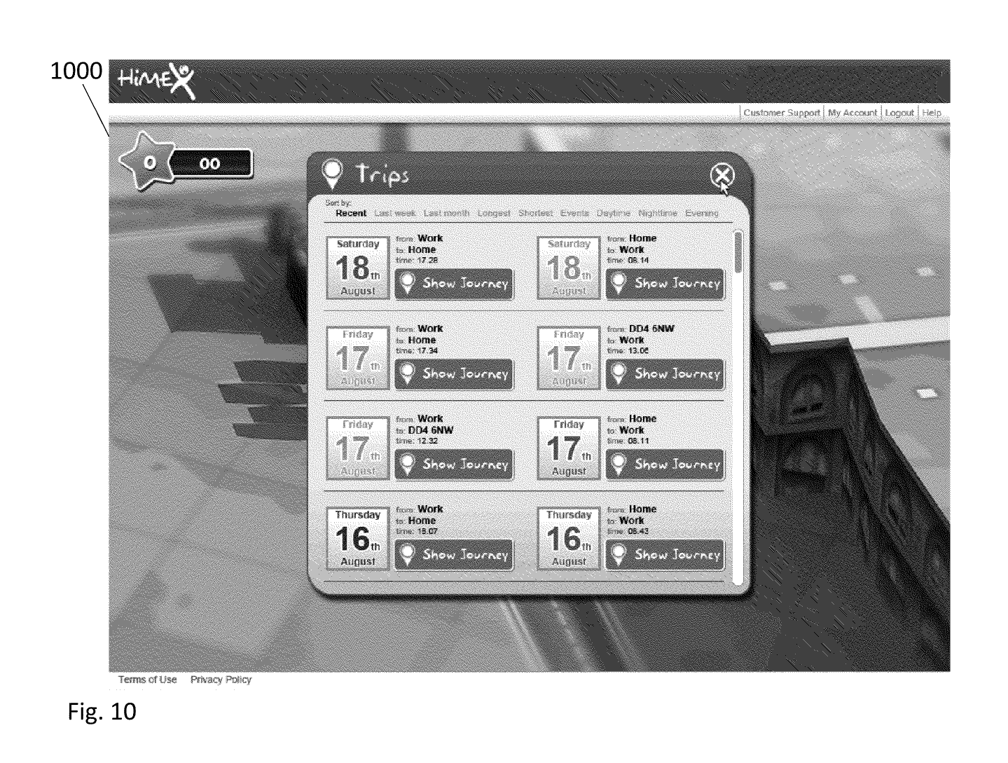

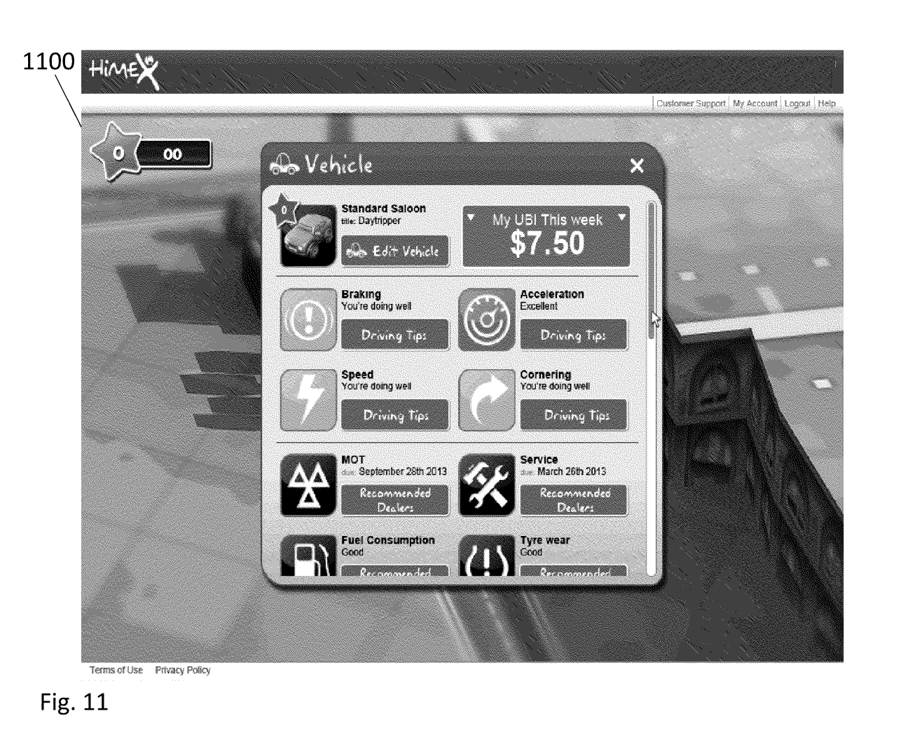

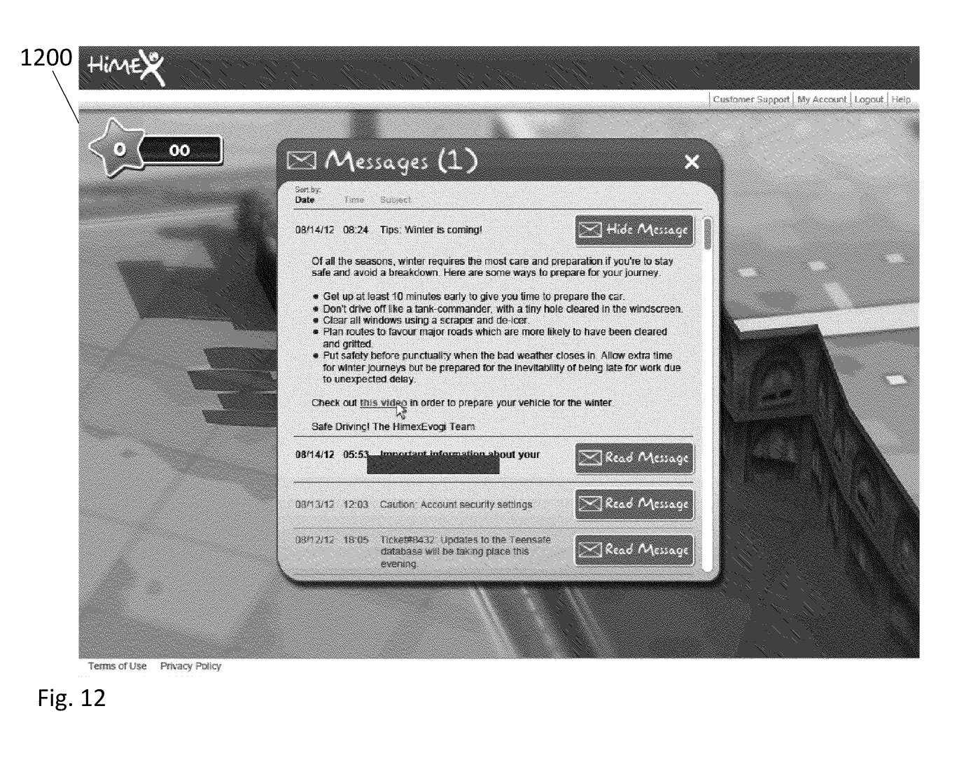

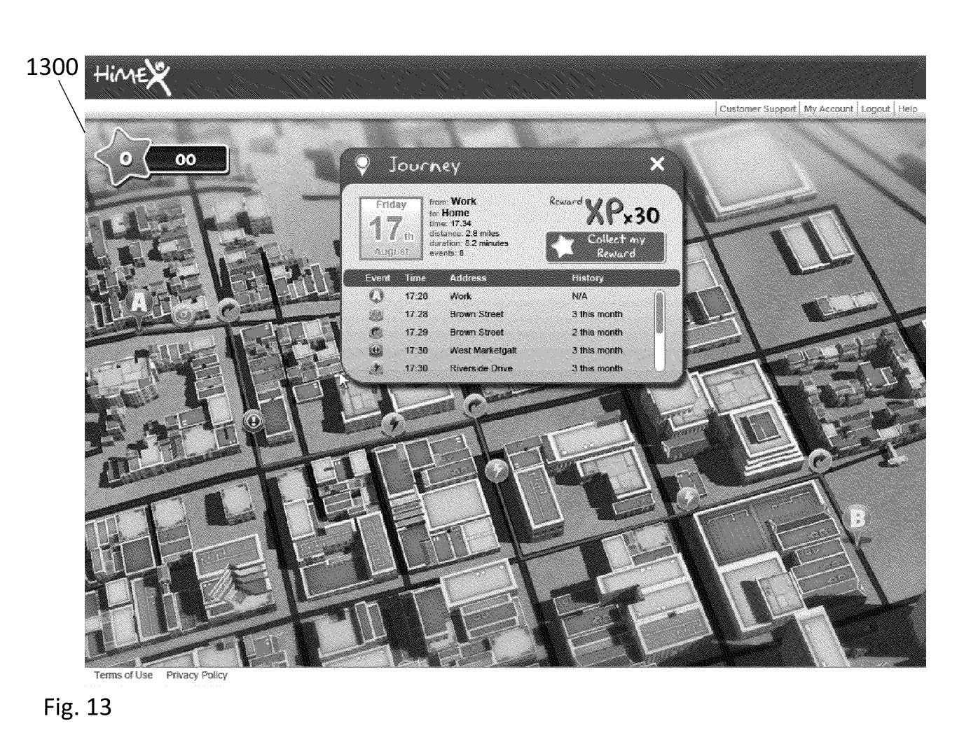

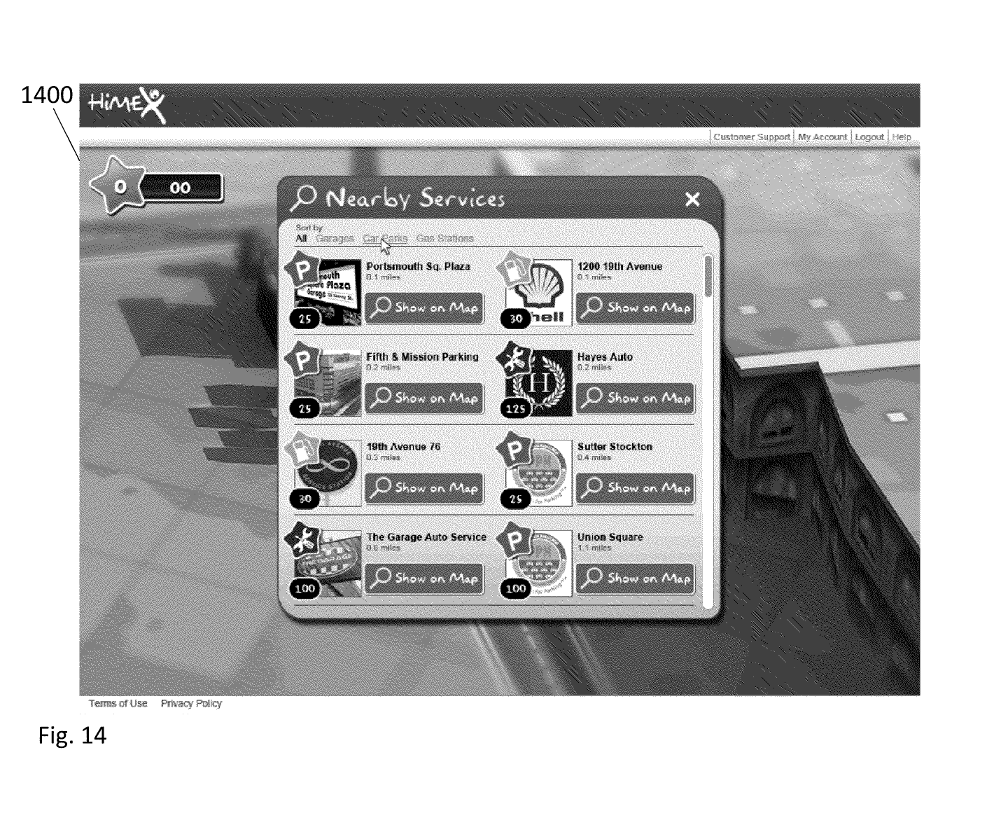

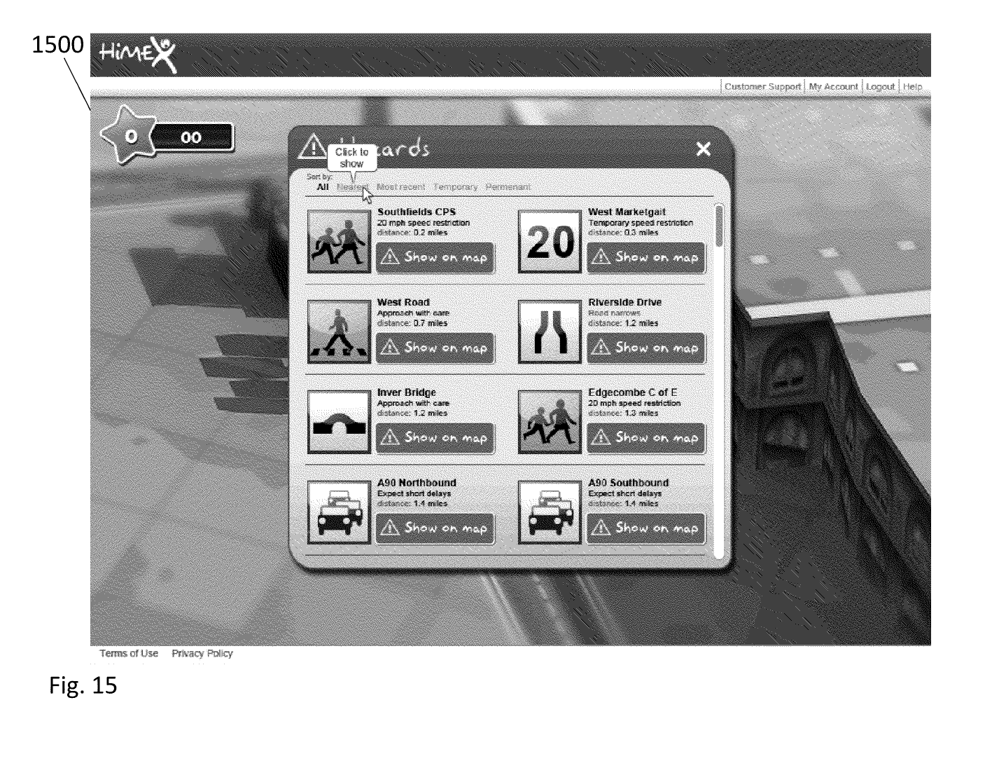

FIGS. 7-16 show exemplary screenshots of a user interface for the application 500. In particular, these figures show exemplary screenshots a user (driver) would see while “playing a game,” for example, in the HIMEX Virtual World gamification platform 200. However, as mentioned above, “while ‘playing a game’” does not equate to “while driving.” As shown in FIG. 8, trip data and performance relative to the selected game can be mapped to the HIMEX Virtual World 3D Live Map 800 on a real-time or near real-time basis. From this screen, by selecting from the various icons, the driver has the option to navigate to other screens, such as, for example: review Friends screen 900 (see FIG. 9); review Trips screen 1000 (see FIG. 10); see Vehicle information screen 1100, such as, for example, Service, Fuel, Maintenance etc. (see FIG. 11); check Messages screen 1200 associated with the Game and the Vehicle (see FIG. 12); review details of Journey screen 1300 (see FIG. 13); view Nearby Services screen 1400 (see FIG. 14); and view Hazards screen 1500 (see FIG. 15).

Referring back to FIG. 5, as the goals of the games are met and/or when a game or task has been completed, the performance and reward algorithm 518 evaluates the results and reports performance information and/or rewards 520 to be presented or offered to the driver. For example, in one embodiment:

Performance and Reward Algorithm 518=f(results of game that was just completed)+f(results of games completed by peer group)+f(results of previous games)+f(rewards offered after previous games)+f(rewards accepted after previous games)+f(driver profile 504)+f(vehicle profile 508)+f(trip detail)

The results of the game that was just completed can include, for example, the time to complete the game, the number of attempts, the actual score, the score vs. average scores in community or group, etc. The results of previous games and rewards offered/accepted after those games involves continuous learning about what motivated engagement in the game. The vehicle profile 508 may suggest, for example, that the age or condition of the vehicle may imply the need for oil change, wiper change, etc. Regarding trip details, travel patterns may be used to present geo-targeted vendor offers.

The performance and reward algorithm 518 can be used for calculating a final score that can be tied to a reward 520. The reward 520 may be calculated based on completing the game and the results achieved during the game. Results from performance and reward algorithm 518 may be sent to the carrier database 506, and/or other linked external database 507 (as shown with dashed line in FIG. 5), and will be matched to available rewards 520. For example, the elements of the performance and reward algorithm 518 may include discrete pass/fail results or ranges of performance for each game. For example, drivers who demonstrate slow speeds and careful cornering during a snowstorm may receive extraordinary credit for their performance, while drivers who do not reduce their speed on an icy road may be additionally penalized. Rewards 520 may be determined accordingly.

For example, in one embodiment:

Reward 520=f(results from games recommended 516)+f(results from algorithm 518)+f(other data)

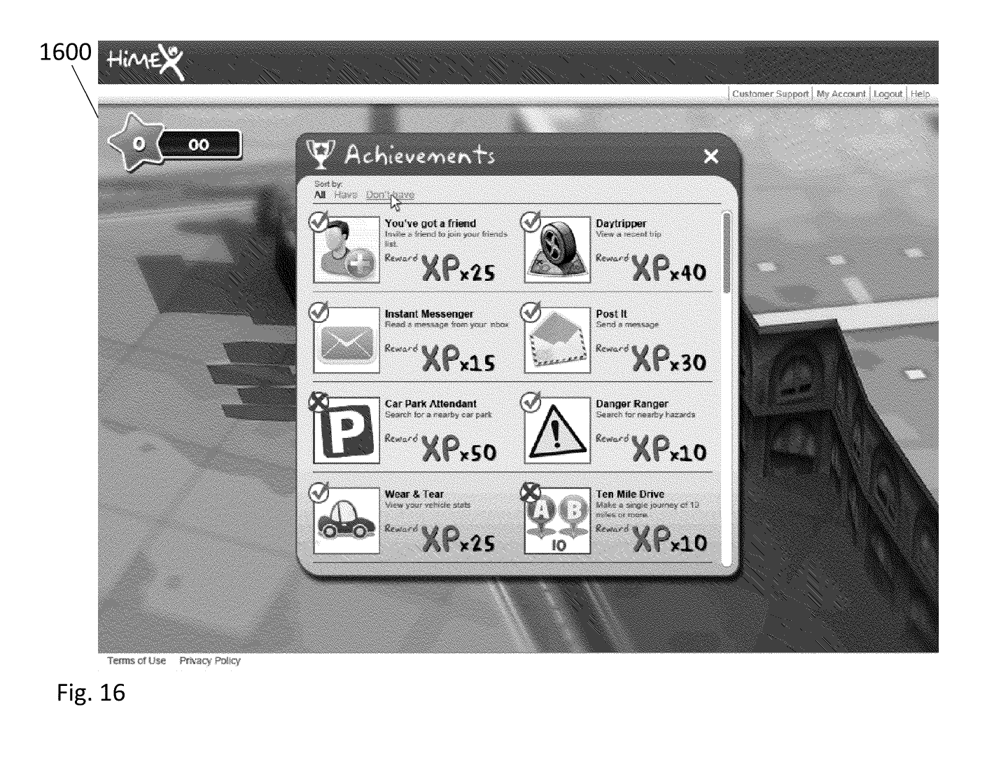

Rewards 520 may be real world and/or virtual world rewards. Rewards 520 can be offered to the driver via the platform 200 and/or via other communication mediums, such as, for example, messages via email, text, or voice. See, for example, the screenshot in FIG. 16, showing Achievements screen 1600. Virtual world rewards may include, for example, game points, badges, status on leaderboards, keys to unlocking more levels within a game or more customization options for virtual vehicles, etc. Real world rewards may include, for example, insurance discounts or products offered by a carrier itself or a third party when the carrier has integrated its insurance offering with the customized platform, such as, for example, discounts on vehicle maintenance, parts, travel or other offers from linked businesses. See, for example, the offers included in the screenshot 1600 in FIG. 16.

A social graph 522 can allow users to share results with participants in pre-defined communities or their own groups, if the driver has enabled that option. Using the social graph 522, drivers can set rules that enable them to access various social based activities, such as, for example, share their results online, post scores in league tables for individual or groups, invite friends to join future events, rate their experience with a game, etc.

In other embodiments, the driver profile 504 can be transformed from static variables to a complex behavioral picture of the changes that result from game-based interactions within the virtual world and the local community. Over time, the game-based results from 518 can also modify or update the driver profile 504, which can then be used as an input to future game-based opportunities presented by the carrier.

In the data analysis module 524, individual and aggregate data is analyzed, for example, for success towards goals, emerging trends, new rating variables, improvements in game mechanics, etc. Results on the current task may be compared to prior tasks and to the database of tasks completed by drivers with similar risk profiles or similar prior performance results. Vehicle diagnostics may be incorporated where variables, such as, for example, engine size, drive train or tire pressure can affect driver performance. Geospatial data can be incorporated for the dates of performance to account for road conditions or time of day, for example. The data can be stored locally or in the cloud, depending on the local storage space and network connectivity data upload speed.

The continuous improvement algorithm 526 can use the driver's games results along with other anonymous performance data from other drivers to further improve and enhance the games recommended to the driver. Over time the platform 200 and/or the process 500 will increase the accuracy of recommending games focusing on specific behavior changes for the driver. For example, a particular driver may always approach a stop sign and have a brake hard event (e.g., a reduction in speed of 7 to 10 miles per second). The process 500 may recommend a game and offer an incentive to help the driver change his behavior so that he does not approach a stop sign at high speed and have to brake hard. In this situation, if the number of hard braking events is reduced, the recommended game will have been deemed a success and the continuous improvement algorithm 526 will update itself and possibly other modules. For example, if the recommended objective (in the form of a game) is achieved by a first driver, then the same objective may be offered to subsequent drivers. If the recommended objective (in the form of a game) is not achieved by a first driver, then the objective and/or incentive may be modified or revised in an attempt to better encourage drivers to achieve the objective of the game.

For example, in one embodiment:

Continuous Improvement Algorithm 526=f(results of game that that was just completed)+f(results of previous games)+f(rewards offered after previous games)+f(rewards accepted after previous games)+f(driving behavior heat map)+f(carrier database 506)+f(other databases 507)

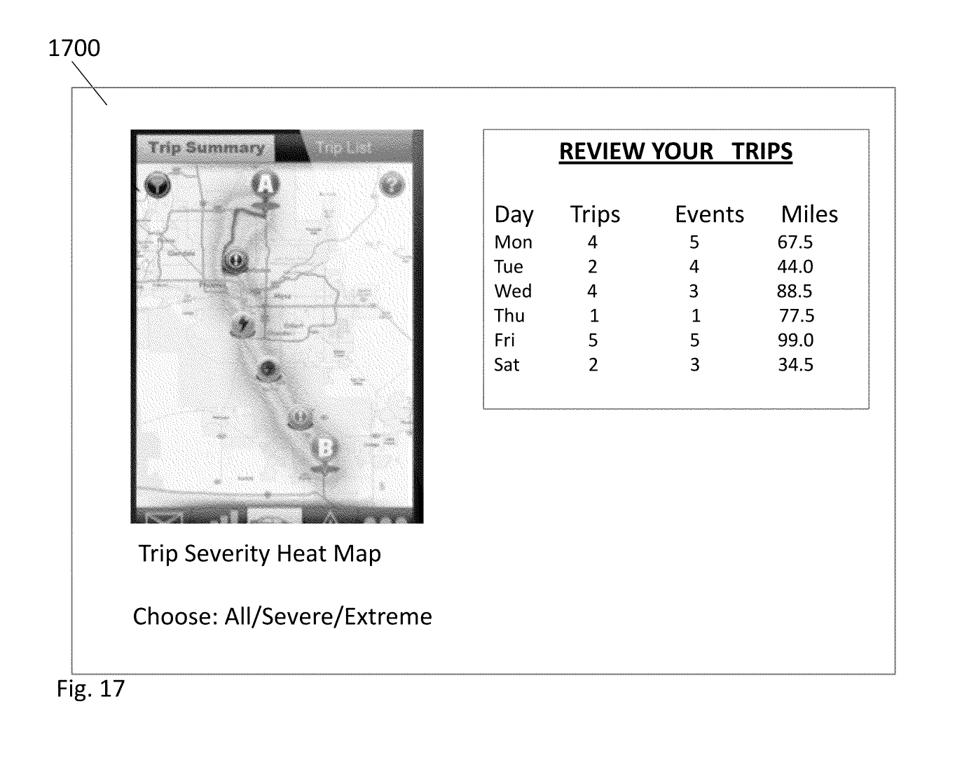

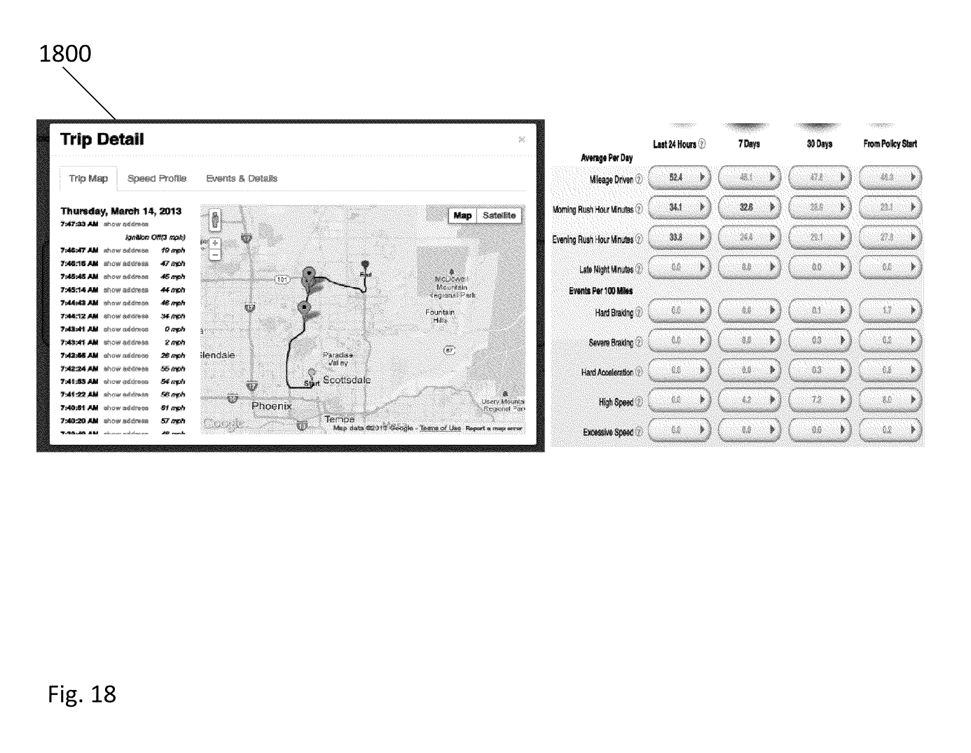

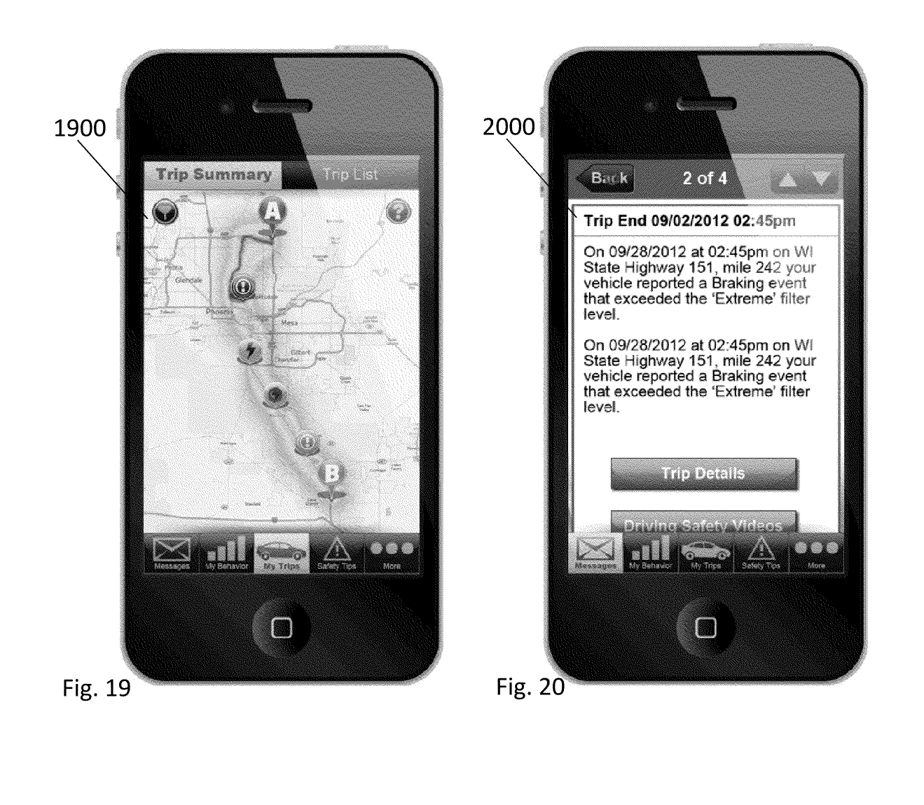

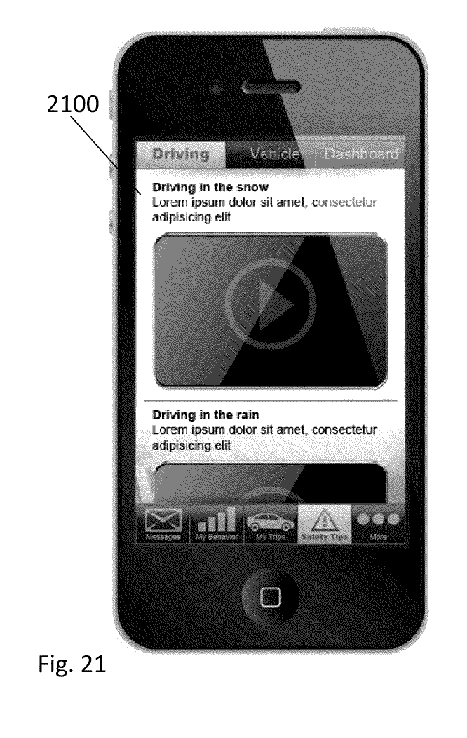

FIG. 17 shows an exemplary heat map 1700. A heat map can use icons (e.g., exclamation point, arrow, lightning) to depict driving events that are at unacceptable levels (e.g., All, Severe, Extreme, etc.). In another embodiment, a driving improvement graph may display trends in driving behavior, when, for example, few or no events are recorded to a heat map. The driver can choose (see bottom left of screenshot 1700 in FIG. 17) what to display. Trips can be listed individually and may be “overlayed” on the map—giving it a “heat map” view, in other words, showing frequency and severity of trip events. FIG. 18 shows an exemplary heat map 1800 with events for one trip. FIG. 19 shows an exemplary heat map 1900 on a mobile device. FIG. 20 shows an exemplary screen 2000 with event details from a heat map, such as, for example, the heat map 1900. In other embodiments, educational information may be supplied as a result of a trip event, as shown in the screen 2100 of FIG. 21.

The platform 200 can compile trips to produce the driving trips and behavior heat map, which can be continually updated as new trips and events are recorded. In addition, within the heat map, the driver may have the option to tag trips as “Retail,” “Friends,” or other tags, allowing various types of Trips to be displayed. In another embodiment, the driver may choose to allow carrier partners (e.g., food, shopping, vehicle-related) to be displayed on trips.)

In one embodiment, for example, the driving behavior heat map may be a function of the following:
Events by
   Type (speeding, cornering, braking, acceleration and combinations)
   Trip (Events per trip, trips with/without Events)
   Day of week and time of day
Route: a function of Trips by
   Frequency (daily, weekly, occasional)
   Efficiency (most direct vs. fastest)
   Travel through “high accident frequency” intersections
   Safe locale (“high theft or claim fraud”)
   Road and traffic conditions
   Weather
Retail: a function of mapping to augment Routes with
   Safety partners (driving schools)
   Automotive partners (oil change, car wash, car parts, repair shop)
   Food & beverage (coffee, fast food)
   Local attractions
   Local offers and vouchers tagged to trips map
Friends: a function of connections
   Drivers among family members
   Drivers among friends using HIMEX Virtual World and Gamification Platform
   Drivers using social media to connect
   Drivers in a geographic community (anonymous)
   Drivers in a insurance community (anonymous)

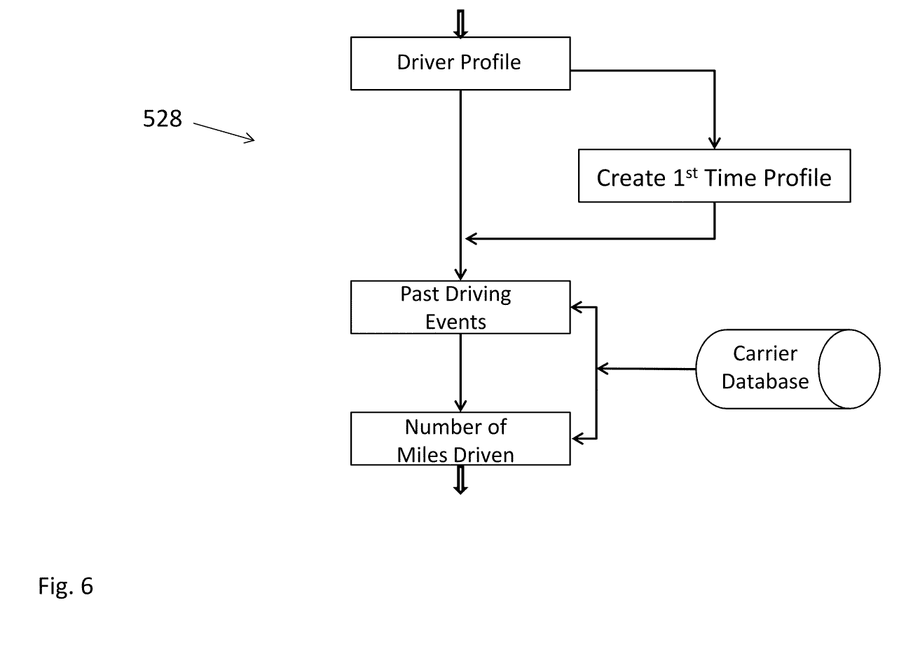

Referring back to FIG. 5, the driver profile update module 528 can transform simple demographic variables into a complex view of behaviors, including learned behaviors from the game-based interactions, allowing carriers to refine their pricing and product offerings, as well as the games offered in future interactions. See FIG. 6 for a depiction of exemplary elements associated with the driver profile update module 528.

In addition to the embodiments above that include an exemplary UBI environment, the platform 200 is also well suited for other applications, including, for example, fleet management for commercial auto insurers and self-insurers. In these embodiments, certain parameters of the platform 200 may be focused differently, such as, for example, the objectives and incentives. However, the capability to track certain metrics, for example, associated with driver behavior and vehicles, for feedback and analysis may be very useful, for example, to determine and minimize risk.

To illustrate the range of applications, some exemplary embodiments follow. These examples are not exhaustive. The gamification platform 200 and its associated processes, when integrated with a carrier's existing systems 122, can create new systems for consumer engagement, new data sets for analysis, and positive outcomes related to safety and risk management. As the user progresses through the carrier's virtual world environment, algorithms can continuously update the user profile and the virtual world itself, transforming individual responses, reactions and results to new insights, which result in new challenges, offers or rewards within the virtual world as well as policy-related offers and rewards.

In a property embodiment, homeowners may accept a mission to mitigate liability risks (find dangerous spots within the home or front yard) or the likelihood of property damage (from flooding, windstorm, dead trees, or attractive nuisance). Rewards and discounts may link the user to local or national affiliates. Neighborhoods may collaborate to achieve broader social goals related to community safety, such as seeking streetlights to deter vandalism or better response times from emergency departments. As the user successfully identifies and mitigates risks, the carrier offers more challenging and rewarding missions and quests. In addition, various devices may be utilized to determine various activities and states that may be applicable to home risk. By utilizing these devices and their data, the above mentioned gamification systems and processes are similarly applicable to property-based embodiments.

An auto insurance embodiment allows parents of teen drivers to use a carrier's customized platform to set goals for driving improvement, receive immediate or periodic notifications of risky driving behaviors, or limit driving distances through geo-fencing. Parents and teens could accept missions for safe driving or mileage reduction, competing for status on local leaderboards, against each other, within a school system or a driving school. As the teen successfully improves driving skills, geofencing or curfew hours could be expanded and new initiatives, such as highway driving or snowy weather driving, could be added. Competition across high schools could incent significant improvements or reductions in hazards, such as texting. Carrier insights into successful challenges transform individual results into new approaches for driving skills training and opportunities for community safety initiatives.

In a commercial fleet embodiment, a customized application could allow management to monitor driving behavior, hours driven and rest stops, fuel efficiency and other critical safety factors—and to provide immediate feedback to drivers. By comparing driver activity to rules defining safe driving behaviors, carriers can re-educate drivers or reward them. Driver improvements may be rewarded within the community by badges, status updates, virtual rewards and insurance savings. Insurance carriers will use data to price renewals, as well as to design effective safety programs for fleets.

In a commercial auto insurer embodiment, data about driver behavior and overall fleet performance can transform the involvement of the carrier, from insurer and risk manager to a key player in the logistics and operations of the business it insures. For example, a company with a fleet of cars for Home Health Care Aides can observe its entire operation within the HIMEX Virtual World. Insights may be gained about travel patterns, time of day/day of week utilization of vehicles, multiple trips to the same client, reconciliation of mileage logs, gas purchase patterns, personal use of employer vehicles, and more.

In a customized driver education embodiment, the application may be designed for senior drivers, a high-risk population that can benefit from regular, real-time reinforcement of safe driving behaviors. Online training combined with game-based learning and rewards can extend their driving life and help seniors maintain independence. Insurers and drivers will benefit by integrating timely training triggered by insurance events (new home, traffic tickets, age change, new car) that signal a need for training, before driving skills deteriorate. Algorithms may predict declines in driving skills before a serious incident occurs, transforming the entire insurance experience from a penalty-mode, involving ever-increasing rates, to a prevention-mode, including training and possible a recommendation that a driving be limited.

Data aggregation and analysis of user engagement with policy-linked game technology expands the range of variables available to property/casualty insurers for product design. Pricing segmentation will therefore become more sophisticated based on identification of groups that respond positively to game-based learning and play. For example, the method facilitates the carrier's ability to segment users who demonstrate a rapid and sustained improvement in driving behaviors. This segment is not identifiable without the integration of the gamification platform 200.

Consumers have little actual awareness of unsafe driving behaviors or dangers in a home that may lead to liability claims. Game-based activity is proven to increase engagement and change behavior—leading to accident reduction or avoidance, greater fuel efficiency, vehicle efficiency, “just in time” vehicle maintenance, improved driver habits, safer homes, increase in the purchase of proper coverage, lower premiums, saving money. Secondly, traditional insurance rating variables rely on groupings of ‘like individuals” for the purpose of setting rates, yet each driver represents a unique set of driving skills and behaviors. Deploying game mechanics to set driving improvement targets and obtain real-time results develops new pricing, product and sales methods.

Integrating behavior change targets with game mechanics can significantly increase consumer engagement with insurance products that are typically low involvement products. The elements of game design, including personalization, quests, rewards and social graphs, bring much-needed motivation and engagement to this high-cost, low interest expenditure. Game mechanics can be customized for specific groups (teen drivers), locales (flood-prone areas of the country), issues (texting while driving), or businesses (truck fleets). Algorithms for setting targets for the user, selecting which games to offer, customizing rewards, and creating iterative driver risk profiles will combine static variables with actions and responses in the carrier's virtual world to continuously transform the user's risk profile and the behaviors associated with risks that affect safety, cost and life.

Alternatives, such as, stand-alone training, classroom education, or online game that are not integrated with a carrier's customer systems, are less effective.

Gamification is rapidly being deployed across non-game businesses, but has yet to be applied to property/casualty insurance. The home insurance market is $73 billion, with approximately $45 billion of that concentrated in the top 10 carriers. 97% of homeowners in the US have home insurance. Average premium is $880.

The private passenger auto insurance market is $167 billion in direct written premium. Commercial auto adds another $23 billion. There are 350+Property/Casualty insurers in the US. 86% of US drivers purchase auto insurance.

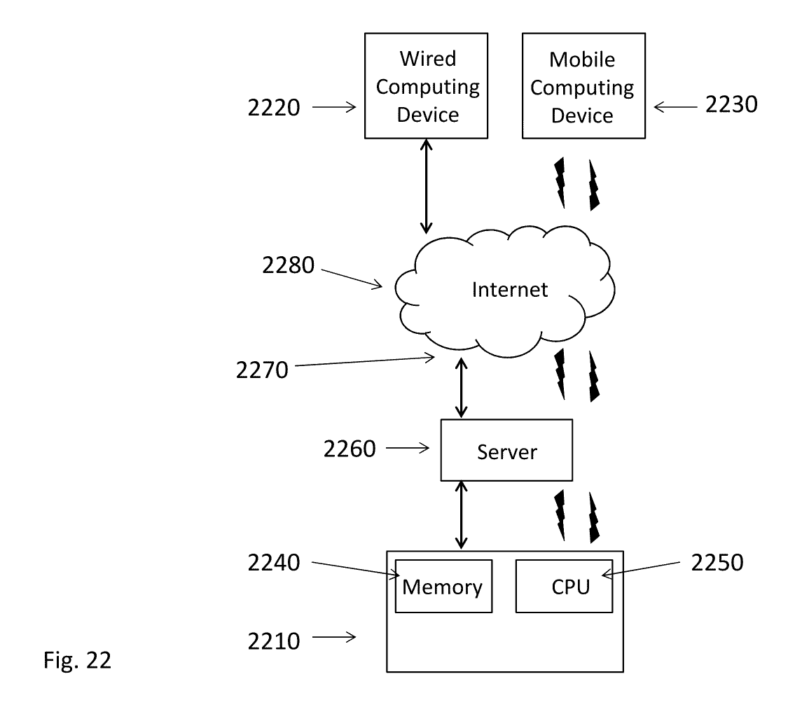

FIG. 22 includes an exemplary depiction of exemplary communication protocols and exemplary devices containing the platform 200 and/or processes 400, 500, and their associated applications. The devices can include the means for executing logic associated with the platform 200 and/or processes 400, 500, and their associated applications. The platform 200 may be executed on a variety of computing devices 2210, including, e.g., wired devices 2220 (e.g., desktop computers) and mobile devices 2230 (e.g., smartphones and tablets), kiosks, or any other device capable of hosting or presenting the platform 200 to a user with a display and input mechanism. The platform 200 may be stored in the memory 2240 of a device and processed by a Central Processing Unit (CPU) 2250. The platform 200 may be stored and accessed via the same device, stored remotely in a first device and accessed via a different second device, or any other combination thereof. The platform 200 and/or its associated logic may be stored in local or remote memory (e.g., of a server 2260), and accessible directly or via a network 2270 (e.g., over the internet 2280). The platform 200 may also be a web-based application accessible via the internet 2280. A database associated with the platform 200 may be located in the same or different memory location than the platform 200. Similarly, a database associated with the platform 200 may be accessed the same way or differently than the platform 200.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicant's general inventive concept.

The following is claimed:

1. A method of providing a game-based driving performance application, the method comprising:
determining an objective associated with driving performance of a driver;
communicating at least one objective to the driver;
receiving data associated with activity related to the objective;
determining a result based on comparing the data to the objective; and
reporting the result to at least one user;
wherein communicating the objective to the driver comprises a game-based interaction.

2. The method of claim 1, further comprising:
offering an incentive to the driver to complete the objective; and
providing the incentive to the driver if the driver completes the objective;
wherein offering the incentive to the driver comprises a game-based interaction.

3. The method of claim 2, wherein the incentive comprises a reduction in the cost of an insurance premium associated with the driver.

4. The method of claim 2, wherein the incentive comprises a virtual incentive.

5. The method of claim 1, wherein determining an objective comprises determining the objective based on prior driving performance of the driver.

6. The method of claim 1, wherein determining an objective comprises determining the objective based on prior results or prior incentives.

7. The method of claim 1, wherein the objective is associated with reducing a risk associated with a driving behavior of the driver.

8. The method of claim 1, wherein the objective comprises a virtual objective, wherein the virtual objective does not require actual driving.

9. The method of claim 1, wherein the objective comprises driving behaviors.

10. The method of claim 1, wherein the at least one user comprises the driver, and wherein reporting the result to the driver comprises a game-based interaction.

11. The method of claim 1, wherein the at least one user is associated with the driving performance application, and wherein reporting the result comprises modifying a profile of the driver.

12. The method of claim 11, wherein the user comprises an insurance carrier or a fleet manager, and the profile of the driver is maintained in a database.

13. The method of claim 1, wherein the data received is captured by a device associated with a vehicle driven by the driver.

14. The method of claim 1, further comprising determining a recommended game for the driver, and wherein the objective is communicated to the driver as a game-based objective.

15. The method of claim 1, wherein the at least one objective is a plurality of objectives, and further comprising receiving an objective selection from the driver.

16. A method of developing an objective for a game-based driving performance application, the method comprising:
receiving data associated with driving performance of a driver;
determining a profile of the driver based on the driving performance of a driver; and
generating the objective based on the profile of the driver, wherein the objective is associated with reducing a risk associated with a driving behavior of the driver.

17. The method of claim 16, wherein the objective comprises a situation associated with a prior situation in the data.

18. The method of claim 16, further comprising determining a vehicle profile.

19. A method of developing objectives for a game-based driving performance application, the method comprising:
generating an objective based on the profile of a first driver, wherein the objective is associated with reducing a risk associated with a driving behavior of the first driver;
communicating the objective to the first driver;
offering an incentive to the first driver to achieve the objective;
determining if the first driver achieves the objective; and
communicating the objective and offering the incentive to a second driver if the first driver achieved the objective.

20. The method of claim 19, further comprising revising the objective if the first driver does not achieve the objective.

21. The method of claim 19, further comprising revising the incentive if the first driver does not achieve the objective.

22. A system for a game-based driving performance application, comprising:
a computer system, comprising a memory and a processor, wherein the memory comprises the application, and wherein the application comprises logic for:
determining an objective associated with driving performance of a driver;
communicating at least one objective to the driver;
receiving data associated with activity related to the objective;
determining a result based on comparing the data to the objective; and
reporting the result to at least one user;
wherein communicating the objective to the driver comprises a game-based interaction.

23. A computer readable medium comprising a game-based driving performance application, wherein the application comprises logic for:
determining an objective associated with driving performance of a driver;
communicating at least one objective to the driver;
receiving data associated with activity related to the objective;
determining a result based on comparing the data to the objective; and
reporting the result to at least one user;
wherein communicating the objective to the driver comprises a game-based interaction.

24. A system for a game-based driving performance application, comprising:
means for determining an objective associated with driving performance of a driver;
means for communicating at least one objective to the driver;
means for receiving data associated with activity related to the objective;
means for determining a result based on comparing the data to the objective; and
means for reporting the result to at least one user;
wherein the means for communicating the objective to the driver comprises a game-based interaction.
